(19) United States
(12) Patent Application Publication
(10) Pub. No.: US 2017/0201196 A1
(43) Pub. Date: Jul. 13, 2017

(54) CHOPPED MOTOR CONTROLLER

(71) Applicant: QUALCOMM Incorporated, San Diego, CA (US)

(72) Inventors: Moses DERKALOUSDIAN, Escondido, CA (US); Adam Edward NEWHAM, Poway, CA (US)

(21) Appl. No.: 14/993,890

(22) Filed: Jan. 12, 2016

(51) Int. Cl. H02P 6/00

(52) U.S. Cl. CPC H02P 6/002

(57) ABSTRACT

A hardware based motor controller may be used to generate chopped signals. The hardware based motor controller may decrease CPU bandwidth needed to perform functions related to motor control. In an aspect of the disclosure, a method and an apparatus are provided. The apparatus may be a motor controller for controlling a brushless motor. The motor controller may include a first carrier generator component for providing a first carrier. The motor controller may also include a first pulse generator component for providing a first pulse at a duty cycle. The first pulse generator component may be coupled to the first carrier generator component. Additionally, the first pulse generator may be configured to combine the first pulse with the first carrier to generate a first output pulse. Additionally, the first pulse generator may also be configured to output the first output pulse to drive a first leg of the brushless motor.

### BACKGROUND

Field

The present disclosure relates generally to motor controllers, and more particularly, to chopped motor controllers.

Background

In order to reduce the power consumption and heat loss of a brushless direct current (DC) motor, an incoming pulse-width modulated (PWM) signal for each phase of the DC motor may be “chopped.” Chopping the signal may be defined as periodically disabling the flow of current through a given motor phase when the phase would normally be energized. Some controllers may support both “hard chopping” and “soft chopping.” Hard chopping is chopping both field effect transistors (FETs) on a given motor phase. Soft chopping is chopping one FET on a given motor phase.

Central processor unit (CPU) based, software driven solutions for chopping take up valuable CPU cycles required to generate the chopped signals. Generating the chopped signals can reduce the CPU bandwidth available for other applications, other algorithms, or both. Additionally, the system power consumption may increase as a result of additional power consumed by the CPU.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Generating chopped signals using a CPU may reduce the CPU bandwidth available for other applications, other algorithms, or both. Additionally, the system power consumption may increase as a result of additional power consumed by the CPU. Accordingly, a hardware based motor controller with an optional feedback mechanism may be used to drive the generation of a chopped signal or signals. The hardware based motor controller may, in some examples, decrease or eliminate the CPU bandwidth needed to perform functions related to motor control. The hardware based motor controller may also, in some examples, decrease or eliminate any increased power usage due to CPU bandwidth needed to perform functions related to motor control.

In an aspect of the disclosure, a method and an apparatus are provided. The apparatus may be a motor controller for controlling a brushless motor. The motor controller may include a first carrier generator component for providing a first carrier. The motor controller may also include a first pulse generator component for providing a first pulse at a duty cycle. The first pulse generator component may be coupled to the first carrier generator. Additionally, the first pulse generator component may be configured to combine the first pulse with the first carrier to generate a first output pulse. Additionally, the first pulse generator may also be configured to output the first output pulse to drive a first leg of the brushless motor.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a simplified circuit diagram illustrating example motor control circuitry in accordance with the systems and methods described herein.

FIG. 2 is a diagram illustrating a series of signals for controlling a motor in accordance with the systems and methods described herein.

FIG. 3 is another diagram illustrating a series of signals for controlling a motor in accordance with the systems and methods described herein.

FIG. 4 is a block diagram illustrating an example portion of a motor controller in accordance with the systems and methods described herein.

FIG. 5 is a block diagram illustrating an example motor controller in accordance with the systems and methods described herein.

FIG. 6 is another block diagram illustrating an example motor controller in accordance with the systems and methods described herein.

FIG. 7 is a block diagram illustrating an example portion of a motor controller in accordance with the systems and methods described herein.

FIG. 8 is a flowchart illustrating an example method for motor control in accordance with the systems and methods described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In order to reduce the power consumption and heat loss of a brushless DC motor, an incoming PWM signal for each phase of the DC motor may be “chopped.” As discussed above, CPU based, software driven solutions for chopping may take up valuable CPU cycles required to generate the chopped signals. Accordingly, CPU based software driven solutions for chopping may reduce the CPU bandwidth available for other applications.

The use of chopped signals may vary depending on ambient temperature, temperature of the motor being controlled, current used by the motor being controlled, and rotational speed of the motor being controlled, to name a few factors. For example, chopping may not be used at very high rotational speeds of the motor being controlled. By not using chopping at very high rotation speeds, torque may be increased. At very high rotational speeds for the motor, temperature and power may generally be less of a consideration because the energy to the motor may be dissipated by the motor generating rotational energy.

Software controlled chopping methods may derive a chopped signal using software. The software may “bit-bang” (continuously write bit values to an output to change the state of the output) to generate the chopped signal. For example, the software may write to a general purpose input/output (GPIO) pin based on a general purpose timer, e.g., in the CPU. Alternatively, the software may write to a general purpose input/output (GPIO) pin based on delays built into the software. The timer or delay interval may be adjusted by software in real time to account for the different periods of the chopped signal. Continuously writing bit values to an output to change the state of the output takes up valuable CPU cycles.

One example provides a custom hardware solution with an optional feedback mechanism to generate a chopped signal or chopped signals to drive a DC motor. By logically connecting the output of N general purpose timers, a normal PWM signal may be modulated by N adjacent signals to generate a new signal. The logic used to connect the output of one timer to another timer may be Boolean logic such as AND, OR, XOR, NAND, NOR, or any combination of Boolean logic, as well as flip-flops, other digital circuitry, or analog circuitry. The systems and methods described herein may enable various custom output signals. In addition, the timer compare logic block may receive an external input from a temperature sensor, current sensor, or speed sensor to allow for dynamically adjusting the PWM duty cycle, the period of the PWM signal, or both based on temperature (e.g., of the motor), current (e.g., supplied to the motor), speed (e.g., rotational speed of the motor), or some combination of temperature, current, or speed without any run-time software interaction. Generating a responsive chopped signal that has been generated using hardware alone (or using a design that decreases the reliance on the CPU) may free CPU cycles to perform other tasks or enter a low power mode to conserve energy. The systems and methods described herein may use hardware alone for generating signals to control a brushless motor. Alternatively, in another example, the systems and methods described herein may use hardware to decrease the reliance on the CPU for generating signals to control a brushless motor.

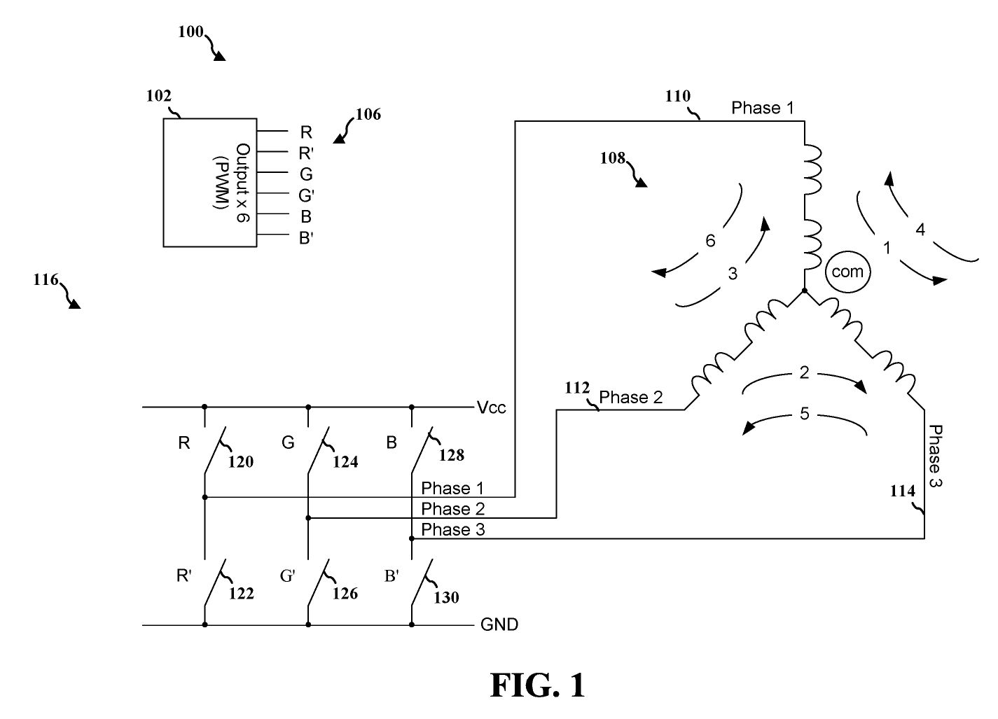

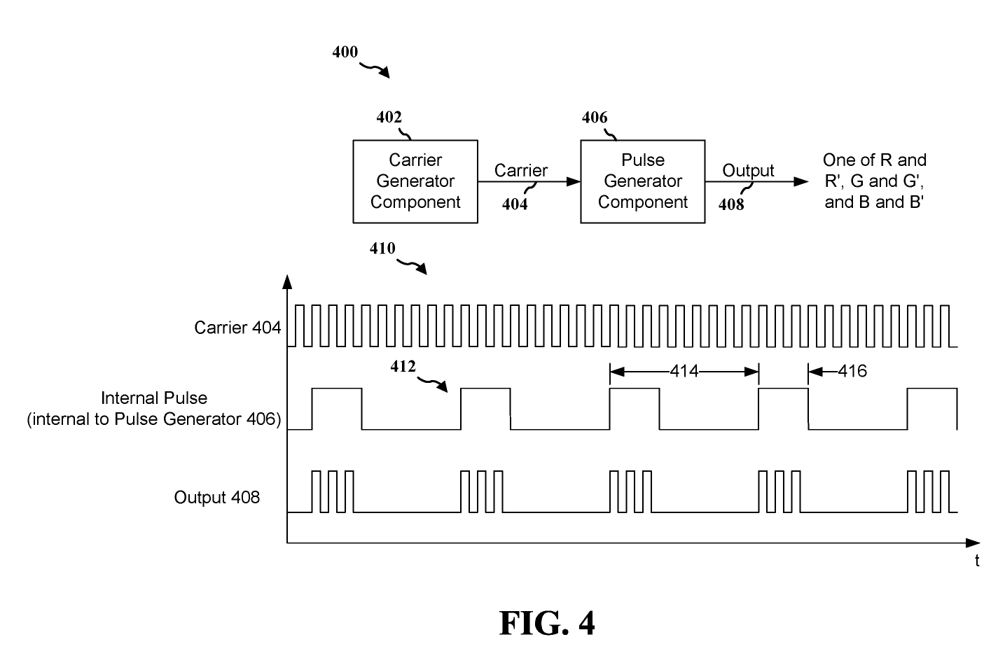

FIG. 1 is a simplified circuit diagram 100 illustrating an example of motor control circuitry in accordance with the systems and methods described herein. The circuit diagram includes a motor controller 102 having a series of outputs 106. The motor controller 102 may control a brushless motor 108. Generally, PWM signals and/or clock signals may be generated internally to the motor controller 102. The motor controller 102 may include a carrier generator component for providing a first carrier, as will be discussed in greater detail with respect to FIGS. 4-7.

The motor controller 102 may output the output pulse to drive a leg of the brushless motor 108. For example, the motor controller 102 may include a series of outputs 106 (R, R′, G, G′, B, B′) that may output the output pulses that drive the legs 110, 112, 114 of the brushless motor 108. As illustrated in FIG. 1, the motor controller 102 outputs 106 (R, R′, G, G′, B, B′) may drive the legs 110, 112, 114 of the brushless motor 108 indirectly, e.g., through circuitry 116.

The circuitry 116 includes switches 120, 122, 124, 126, 128, 130. The switches 120, 122, 124, 126, 128, 130 may be electrically controlled. For example, the switches 120, 122, 124, 126, 128, 130 may be p-channel Metal Oxide Semiconductor (PMOS) transistors, n-channel Metal Oxide Semiconductor (NMOS) transistors, Bipolar Junction Transistors (BJT), other types of transistors, or some combination of different types of transistors. The switches 120, 122, 124, 126, 128, 130 may be active high, active low, or some combination. (For the purposes of the discussion below, assume the switches are active high, meaning that the switches are closed when the particular signal controlling the switches is a logical high value.) The R signal from the motor controller 102 controls the switch 120. The R′ signal from the motor controller 102 controls the switch 122. The G signal from the motor controller 102 controls the switch 124. The G′ signal from the motor controller 102 controls the switch 126. The B signal from the motor controller 102 controls the switch 128. The B′ signal from the motor controller 102 controls the switch 130.

Generally, in proper operation, the motor controller 102 will never activate the R signal from the motor controller 102 and the R′ signal from the motor controller 102 at the same time, as this would lead to a short between Vcc and ground. Similarly, the motor controller 102 will generally never activate the G signal from the motor controller 102 and the G′ signal from the motor controller 102 at the same time, as this would also lead to a short between Vcc and ground. Additionally, the motor controller 102 will generally never activate the B signal from the motor controller 102 and the B′ signal from the motor controller 102 at the same time, as this would also lead to a short between Vcc and ground. The motor controller 102 will generally activate some combination of one of the R signal, the G signal, or the B signal in conjunction with some combination of one of the R′ signal, the G′ signal, or the R′ signal, where the R signal and the R′ signal, the G signal and the G′ signal, and the B signal and the B′ signal are not activated at the same time because this would lead to a short between Vcc and ground.

As an example, when the motor controller 102 activates the switch 120 by causing the R signal to be a high value and activates the switch 130 by causing the B′ signal to be a high-value, the current will flow through the phase 1 coils of the brushless motor 108, through the common (com), and through the phase 3 coils of the brushless motor 108, along the current path indicated as current path 1 (see the arrow marked 1). Similarly, when the motor controller 102 activates the switch 124 by causing the G signal to be a high value and activates the switch 130 by causing the B′ signal to be a high-value, the current will flow through the phase 2 coils of the brushless motor 108, through the commutator, and through the phase 3 coils of the brushless motor 108, along the current path indicated as path 2 (see the arrow marked 2). When the motor controller 102 activates the switch 124 by causing the G signal to be a high value and activates the switch 122 by causing the R′ signal to be a high-value, the current will flow through the phase 2 coils of the brushless motor 108, through the commutator, through the phase 1 coils of the brushless motor 108 along the current path indicated as path 3 (see the arrow marked 3).

When the motor controller 102 activates the switch 128 by causing the B signal to be a high value and activates the switch 122 by causing the R′ signal to be a high-value, the current will flow through the phase 3 coils of the brushless motor 108, through the commutator, and through the phase 1 coils of the brushless motor 108 along the current path indicated as path 4 (see the arrow marked 4). When the motor controller 102 activates the switch 128 by causing the B signal to be a high value and activates the switch 126 by causing the G′ signal to be a high-value, the current will flow through the phase 3 coils of the brushless motor 108, through the commutator, and through the phase 2 coils of the brushless motor 108, along the current path indicated as path 5 (see the arrow marked 5). When the motor controller activates the switch 120 by causing the R signal to be a high value and activates the switch 126 by causing the G′ signal to be a high-value, the current will flow through the phase 1 coils of the brushless motor 108, through the commutator, and through the phase 2 coils of the brushless motor 108 along the current path indicated as path 6 (see the arrow marked 6).

As described herein, driving a leg 110, 112, 114 of a brushless motor 108 may generally include driving signals R, R′, G, G′, B, B′ that controls switches 120, 122, 124, 126, 128, 130 respectively to provide power to the brushless motor 108 as described with respect to FIG. 1. Furthermore, an output driving a leg 110, 112, 114 of a brushless motor 108 may generally include driving signals R, R′, G, G′, B, B′ that control switches 120, 122, 124, 126, 128, 130 to provide power to the brushless motor 108. Another output will generally also have to be driven in conjunction with the first output so that a second signal R, R′, G, G′, B, B′ that controls a second switch 120, 122, 124, 126, 128, 130 may allow the first switch 120, 122, 124, 126, 128, 130 and the second switch 120, 122, 124, 126, 128, 130 to complete the power circuit through the brushless motor 108, e.g., as described above with respect to FIG. 1.

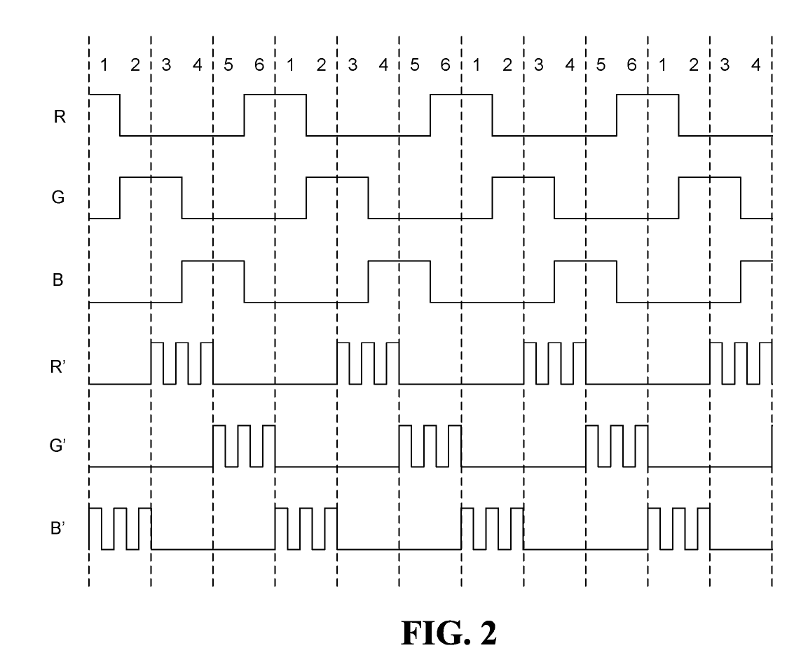

FIG. 2 is a diagram illustrating a series of signals for controlling a motor in accordance with the systems and methods described herein. As described above, in order to reduce the power consumption and heat loss of a brushless DC motor, an incoming PWM signal for each phase of the DC motor may be “chopped.” Chopping the signal may be defined as periodically disabling the flow of current through a given motor phase when the phase would normally be energized. Some controllers may support both “hard chopping” and “soft chopping.” Hard chopping is chopping both of a pair of signals, e.g., R and R′, G and G′, and B and B′. Soft chopping is chopping just one of the pair of signals, e.g., for pairs of signals R and R′, G and G′, and B and B′, soft chopping may be chopping only R, G, and B or soft chopping may be chopping only R′, G′, and B′. FIG. 2 illustrates an example of soft chopping with only the signals R′, G′, and B′ being chopped and the signals R, G, and B not being chopped. The signals R, G, and B and the signals R′, G′, and B′ may drive a brushless motor, as described with respect to FIG. 1. The example used with respect to FIGS. 1 and 2 (as well as other figures in the application) generally refers to a brushless motor having three phases. It will be understood that other brushless motors having differing numbers of phases may be controlled using the systems and methods described herein by generating more (or fewer) signals to drive the motor.

FIG. 2 also includes a series of numbers (1, 2, 3, 4, 5, and 6, generally repeating) running across the top of the diagram. The series of numbers (1, 2, 3, 4, 5, and 6) running across the top of the diagram refer to the numbered current paths (1, 2, 3, 4, 5, and 6) from FIG. 1. As illustrated in FIG. 2, in one example, current will generally flow through the numbered current paths (1, 2, 3, 4, 5, and 6) from FIG. 1. The currents flowing through the numbered current paths (1, 2, 3, 4, 5, and 6) may cause a shaft in the brushless motor 108 to spin in a particular direction. (A different set of pulses may cause the shaft in the brushless motor 108 to spin in the opposite direction, as will be understood by those of skill in the art.)

The distances between the un-chopped pulses (e.g., R, G, or B) connected to a given phase and the distances between chopped pulses (e.g., groups of smaller pulses for R′, G′, or B′) of a given phase may generally be related to the speed at which the shaft of the brushless motor 108 may spin. The active time of the un-chopped pulses (R, G, or B) and the active time of the chopped pulses (groups of smaller pulses for R′, G′, or B′) may generally be related to the power supplied to the brushless motor 108. When chopping is used, the active time of the chopped pulses (groups of smaller pulses for R′, G′, or B′) may generally be controlling with respect to the power supplied to the brushless motor 108 because current will only flow when one of the un-chopped pulses (R, G, or B) and one of the chopped pulses (groups of smaller pulses for R′, G′, or B′) are active at the same time to form a completed circuit between Vcc and ground, through coils in the brushless motor 108 as described above.

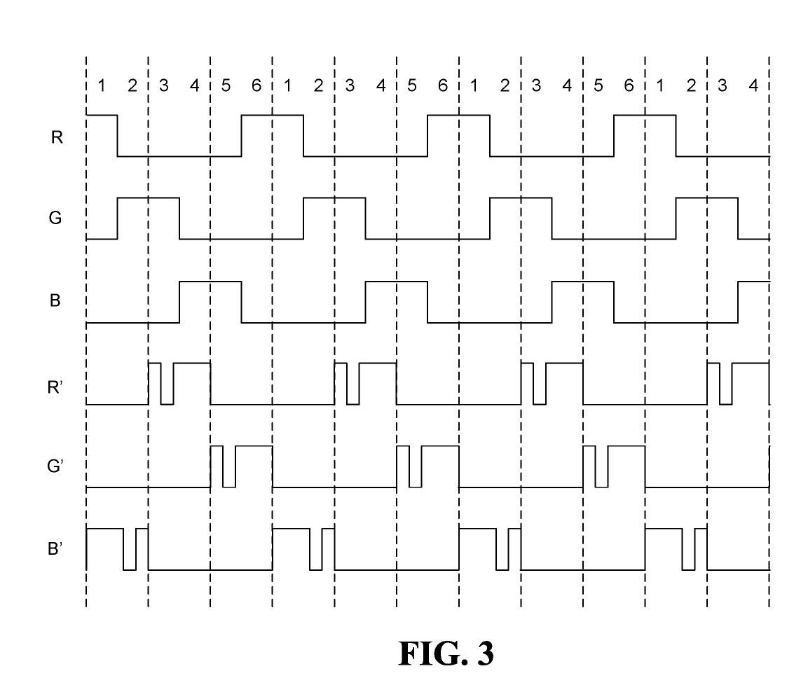

FIG. 3 is another diagram illustrating a series of signals for controlling a motor in accordance with the systems and methods described herein. As described above, in order to reduce the power consumption and heat loss of a brushless DC motor, an incoming PWM signal for each phase of the DC motor may be “chopped.” FIG. 3 illustrates different chopping waveforms on the R′ signal, the G′ signal, and the B′ signal. The chopping waveforms illustrated in FIG. 3 for the R′ signal, the G′ signal, and the B′ signal generally includes a short pulse and a longer pulse. As illustrated in FIG. 3 for the R′ signal, the G′ signal, and the B′ signal, the ordering of the short pulse and the longer pulse may vary from one signal (e.g., the R′ signal or the G′ signal) and another signal (e.g., the B′ signal). The different sets of pulses (the R signal, the R′ signal, the G signal, the G′ signal, the B signal, the B′ signal) illustrated in FIGS. 2 and 3 may be generated by using sets of counter circuits within the motor controller 102, as will be discussed in more detail below.

FIG. 4 is a block diagram 400 illustrating an example portion of a motor controller in accordance with the systems and methods described herein. The motor controller may be for controlling a brushless motor, e.g., brushless motor 108 of FIG. 1. FIG. 4 illustrates a carrier generator component 402 for providing a carrier 404 to a pulse generator component 406. As illustrated in FIG. 4, the carrier 404 may be a square wave 410. Additionally, other signals may be used, however. The square wave 410 is generally illustrated as having a 50% duty cycle. It will be understood, however, that other duty cycles are possible. The duty cycle selected may generally depend on the power needs of the brushless motor 108. As more power is needed by the brushless motor 108, the percentage of the time that the signal is high may increase. For example, when the conditions for the motor are such that chopping is not needed, the carrier signal may remain high so that no chopping occurs.

The pulse generator component 406 provides an output 408 that may be used to drive one leg 110 of the brushless motor 108. The pulse generator 406 may generate an internal pulse 412. The internal pulse 412 may be combined with the carrier 404 to generate the output 408. For example, the internal pulse 412 may be combined with the carrier 404 to generate the output 408 by “ANDing” the internal pulse 412 with the carrier 404. In other examples, the internal pulse 412 may be combined with the carrier 404 using other Boolean logic, such as OR, NOR, NAND, other logical operators, combinations of logical operators, as well as latches, flip-flops, or other digital or analog circuitry. Furthermore, while the examples described herein generally relate to using a single carrier generator component 402 and a single pulse generator component 406 to generate a single output 408, other examples, may use one or more carrier generator components 402 in combination with one or more pulse generator components to generate a single output 408. Boolean logic may be used to combine one or more carriers 404 with one or more internal pulses 412 to generate an output 408, e.g., to generate more complicated signal patterns such as those illustrated in FIG. 3 with respect to R′, G′, and B′.

As discussed above, the duty cycle of the carrier may change depending on the power needs of the brushless motor 108. For example, FIG. 2 illustrates soft chopping. With soft chopping, not all of the signals driving a brushless motor are chopped. FIG. 4 illustrates an example portion of a motor controller that may be used to generate one of the signals R, R′, G, G′, B, and B′ illustrated in FIG. 2. R, G, and B illustrated in FIG. 2 are not chopped. One of R, G, and B (when not chopped) may be generated using the internal pulse 412 and combining it with the carrier 404 that has a 100% duty cycle. Conversely, in the example of FIG. 2, R′, G′, and B′ are chopped. One of R′, G′, and B′ (when chopped) may be generated using the internal pulse 412 combined with the carrier 404 when the carrier 404 does not have a 100% duty cycle.

In another example, rather than always combining the carrier 404 and the internal pulse 412 to generate the output 408 and using a carrier 404 with a 100% duty cycle when chopping is not needed, the internal pulse 412 may be used directly (without combining it with the carrier 404, e.g., square wave 410) when chopping is not needed. In the example of FIG. 2, one of R, G, and B (when not chopped) may be generated using the internal pulse 412 alone, e.g., not combined with the carrier 404. Conversely, in the example of FIG. 2, R′, G′, and B′ are chopped. One of R′, G′, and B′ (when chopped) may be generated using the internal pulse 412 combined with the carrier 404. It will be understood that the pulses illustrated in FIG. 2 and FIG. 4 are only intended to be examples. Other carriers, other pulses, and other combinations of carriers and pulses may be used to generate the output 408.

The pulse generator component 406 may generate an internal pulse 412 at a duty cycle. While the duty cycle of the carrier 404 generated may depend on the power requirements of the brushless motor, the duty cycle of the internal pulse 412 may depend on the desired rotational velocity of the brushless motor and the power requirements of the brushless motor 108. For example, the distance 414 between the internal pulses 412 may determine the speed that the shaft of the brushless motor 108 rotates. The length 416 of each individual pulse of the internal pulses 412 may, in conjunction with the duty cycle of the carrier 404, determine the power supplied to the brushless motor. The duty cycle of the internal pulse 412 is a function of the distance 414 between the internal pulses 412 and the length 416 of each individual internal pulse 412. Thus, the duty cycle of the internal pulse 412 may be impacted by both the desired rotational velocity of the brushless motor and the power requirements of the brushless motor 108.

As illustrated in FIG. 4, the pulse generator component 406 may be coupled to the carrier generator component 402 so that the signals from the pulse generator component 406 and the carrier generator component 402 may be combined. For example, the pulse generator component 406 may combine the internal pulse 412 with the carrier 404 to generate an output pulse 408, e.g., using Boolean logic. The pulse generator component 406 may then output the output pulse to drive a leg 110, 112, 114 of the brushless motor 108. As described above, the block diagram of FIG. 4 illustrates a portion of a motor controller. As discussed with respect to FIG. 1, two output signals may be used to drive a leg 110, 112, 114 of the brushless motor 108. Accordingly, two of the portions illustrated in FIG. 4 may be used to produce two outputs that, together, drive a leg 110, 112, 114 of the brushless motor 108. For example, one of these portions of the motor controller may drive the R signal and another portion of the motor controller may drive the B′ signal to cause current to flow along current path number 1 of the numbered current paths (1, 2, 3, 4, 5, and 6) from FIG. 1 and as illustrated in FIG. 2 by the number “1” of the series of numbers (1, 2, 3, 4, 5, and 6) running across the top of the diagrams of FIGS. 2 and 3.

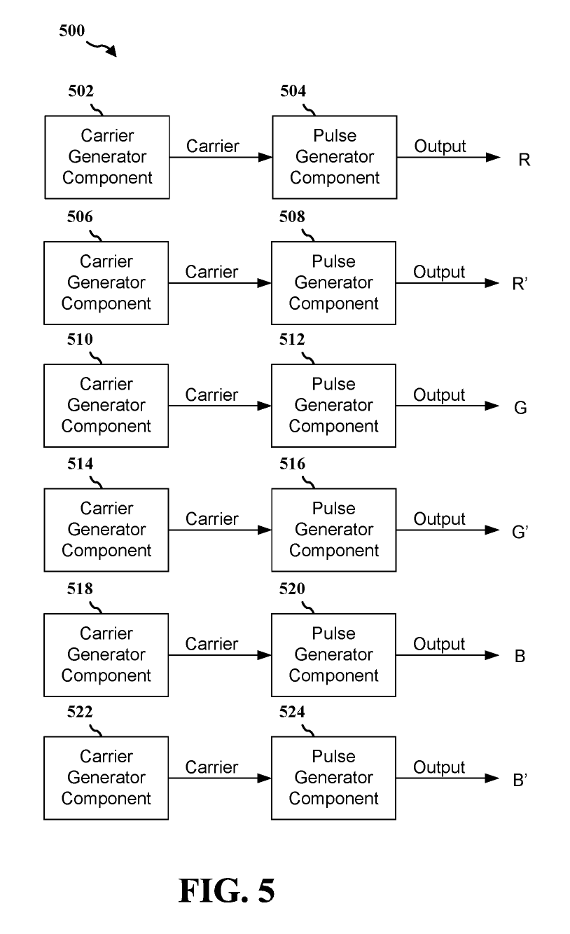

FIG. 5 is a block diagram 500 illustrating an example motor controller in accordance with the systems and methods described herein. The motor controller may be for controlling a brushless motor, e.g., brushless motor 108 of FIG. 1. The diagram of FIG. 5 is generally similar to the diagram of FIG. 4, however, the diagram of FIG. 5 illustrates multiple carrier generator components 502, 506, 510, 514, 518, 522, each for providing carriers to one of multiple pulse generator components 504, 508, 512, 516, 520, 524. The pulse generator components 504, 508, 512, 516, 520, 524 provide outputs R, R′, G, G′, B, and B′, respectively, that may each be used to drive one leg 110, 112, 114 of the brushless motor 108. The pulse generator components 504, 508, 512, 516, 520, 524 may generate internal pulses, as generally discussed regarding internal pulse 412 with respect to FIG. 4. The internal pulses may each be combined with one of the carriers from one of the multiple carrier generator components 502, 506, 510, 514, 518, 522, to generate an output (R, R′, G, G′, B, and B′). Two portions of the motor controller illustrated in FIG. 4 (FIG. 4 illustrates a single portion of the motor controller) may be used together to drive a leg 110, 112, 114 of the brushless motor 108. For example, R and B′, R and G′, G and R′, G and B′, B and R′, B and G′ are all possible combinations of outputs that may be used to drive a brushless motor 108 as discussed with respect to FIG. 1.

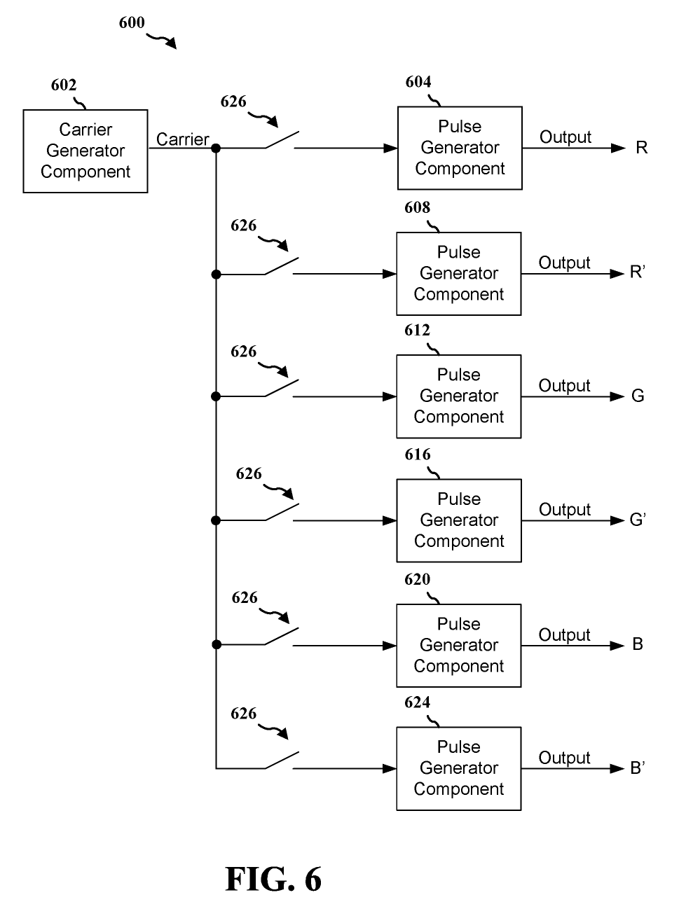

FIG. 6 is another block diagram 600 illustrating an example motor controller in accordance with the systems and methods described herein. The motor controller may be for controlling a brushless motor, e.g., brushless motor 108 of FIG. 1. The diagram of FIG. 6 is generally similar to the diagrams of FIGS. 4 and 5, however, the diagram of FIG. 6 illustrates using a single carrier generator components 602 for providing a single carrier to multiple pulse generator components 604, 608, 612, 616, 620, 624. The pulse generator components 604, 608, 612, 616, 620, 624 provide outputs R, R′, G, G′, B, and B′, respectively that may be used in pairs to drive one leg 110, 112, 114 of the brushless motor 108. The pulse generator components 604, 608, 612, 616, 620, 624 may generate internal pulses, as generally discussed with respect to internal pulse 412 with respect to FIG. 4. The internal pulses may each be combined with the carrier from the carrier generator component 602 to generate an output (R, R′, G, G′, B, and B′). Two of the portions of the motor controller illustrated in FIG. 4 (FIG. 4 illustrates a single portion of the motor controller) may each produce an output. Two outputs, used together, may drive a leg 110, 112, 114 of the brushless motor 108. For example, R and B′, R and G′, G and R′, G and B′, B and R′, B and G′ are all possible combinations of outputs that may be used to drive a brushless motor 108 as discussed with respect to FIG. 1.

In some examples, one or more switches 626 may be used to control if chopping occurs. The switches 626 may be used to disconnect the carrier generator component 602 from the pulse generator components 604, 608, 612, 616, 620, 624. When the carrier signal is used to chop an output signal and carrier generator component 602 is disconnected from the pulse generator components 604, 608, 612, 616, 620, 624 the outputs may not be chopped. In other examples, chopping or not chopping may be controlled internally to the pulse generator components 604, 608, 612, 616, 620, 624.

As described herein, the carrier 404 has generally been depicted as the higher frequency signal with respect to the internal pulse 412. It will be understood, however, that the components generating the higher frequency signal and the lower frequency signal may be swapped relative to the examples described herein. For example, the carrier generation component 602 may generate the lower frequency signal and the pulse generator components 604, 608, 612, 616, 620, 624 may generate the higher frequency signals in another example. Referring back to FIG. 5, the carrier generation components 502, 506, 510, 514, 518, 522 may generate lower frequency signals and the pulse generator components 504, 508, 512, 516, 520, 524 may generate the higher frequency signals in another example.

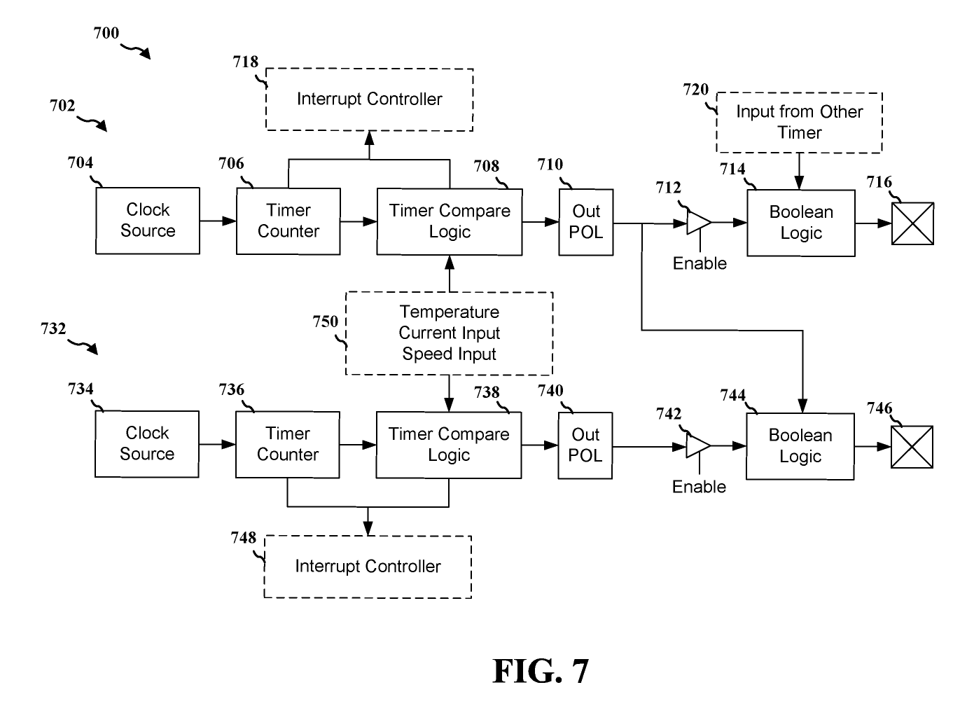

FIG. 7 is a block diagram 700 illustrating an example portion of a motor controller in accordance with the systems and methods described herein. The portion of the motor controller illustrated in FIG. 7 includes a first signal generation circuit 702 and a second signal generation circuit 732. Some examples may also include one or more additional signal generation circuits (not shown) to allow for the generation of more complicated waveforms. In some examples, the first signal generation circuit 702 may perform carrier generation and the second signal generation circuit 732 may perform pulse generation. The first signal generation circuit 702 and the second signal generation circuit 732 may generally include the same functional blocks, as illustrated in FIG. 7, although this is not required. Furthermore, the first signal generation circuit 702 and the second signal generation circuit 732 may also share some functional blocks, as illustrated in FIG. 7, e.g., the temperature, current input, and speed input block 750 is shared between the first signal generation circuit 702 and the second signal generation circuit 732.

In the example of FIG. 7, the first signal generation circuit 702 includes a clock source 704 for generating a clock signal. In some examples, a single clock source, such as clock source 704 may be used for multiple signal generation circuits, e.g., first signal generation circuit 702, second signal generation circuit 732, and other signal generation circuits. The clock signal may be used to drive a clock input to a timer counter 706 and to synchronize the circuitry in the first signal generation circuit 702. Additionally, the clock signal generated may be used to generate an output signal of the first signal generation circuit 702, e.g., a carrier.

The clock source 704 may feed a timer counter 706 that may be used to determine timing for carrier signal generation in conjunction with a timer compare logic 708. The timer compare logic 708 may be configured to determine when specific clock values from the timer counter 706 occur in order to generate the carrier. The block 708 may be used to generate both a signal's frequency and the signal's duty cycle. For example, comparing the count from the timer counter 706 to a first compare value may cause the count from the timer counter 706 to be reset to 0 (e.g., assuming up counter). Similarly, comparing the count from the timer counter 706 to a second compare value may cause an output single of the timer compare logic 708 to toggle (e.g., if the count value is greater than the second compare value, output a logical high value, otherwise output a logical low value). Naturally, the first compare value is greater than the second compare value for this example.

In some examples, the timer compare logic 708 may compare a count from the timer counter 706 to one or more comparison values that may be stored in the timer compare logic to determine when one or more specific clock values from the timer counter 706 occur. The occurrence of the counter values may indicate that a change in the value of a signal should occur, e.g., a change from a low value to a high value or a change from a high value to a low value. A series of changes from a low value to a high value and from a high value to a low value may occur to generate the carrier. These changes in value may generally occur without any “bit banging” by a processor (not shown) in a motor control system implementing the systems and methods described herein. Accordingly, processor overhead related to motor control may be decreased.

The timer counter 706 and/or the timer compare logic 708 may provide an output to an interrupt controller 718 that may interrupt a CPU based on the occurrence of various timing events in the generation of the carrier. For example, an interrupt may be generated by the interrupt controller 718 periodically based on the result of a compare in the timer compare logic 708. The interrupt may be used to keep a CPU in a system implementing the systems and methods described herein aware of one or more events in the generation of the carrier, e.g., a particular number of counts occurring at counter 706, the occurrence of a particular count, or other events.

Additionally, the timer compare logic 708 may be provided with one or more inputs from the temperature, current input, and speed input block 750. The temperature, current input, and speed input block 750 may provide a signal or signals related to one or more of the temperature, the current input, or the speed of a motor being controlled using the portion of the motor controller. The temperature, current, and speed of the motor may impact the control signals sent to the motor. For example, for low temperatures, chopping may not be necessary. For high temperatures, chopping may be needed to stabilize or decrease the temperature of the motor. For high speeds on the motor, chopping may not be needed because higher current that may be provided by un-chopped signals may be needed to increase torque. For lower speeds, the energy from the current may be dissipated as heat, which may lead to a need to chop the motor's input signals, e.g., to decrease power into the motor. Furthermore, the current used by the motor may also provide an indication if chopping is needed or not needed because the energy from the current may be dissipated as heat. Additionally, the feedback from the temperature, current input, and speed input block 750 may be used to alter both frequency and duty cycle of carriers and pulse generators. Accordingly, in addition to altering the chopping or carrier signal, some examples may use feedback from the temperature, current input, and speed input block 750 to alter pulse generator control signals. For example, frequency and duty cycle may be altered to decrease temperature of a motor, lower the current being supplied to the motor, decrease the rotational speed of the motor, or some combination of these.

The timer compare logic 708 may drive an Output POLarity block (Output POL) 710 that may drive Boolean logic 744 in the second signal generation circuit 732. Accordingly, the buffer 712, Boolean logic 714, and output pin 716 may be unused in the first signal generation circuit 702. (In other examples, the buffer 712, Boolean logic 714, and output pin 716 may be used to drive an output signal, e.g., a carrier or a pulse.) Additionally, the input from another timer 720 may be unused in the first signal generation circuit 702.

In the example of FIG. 7, the second signal generation circuit 732 may include a clock source 734 for generating a clock signal. (As discussed above, in some examples, a single clock source, e.g., first clock source 704, may be used for multiple signal generation circuits.) The clock signal may be used to drive a clock input to a timer counter 736 and to synchronize the circuitry in the second signal generation circuit 732. Additionally, the clock signal generated may be used to generate an output signal of the second signal generation circuit 732, e.g., a pulse. Generating the output signal may also use a carrier from the first signal generation circuit 702.

The clock source 734 may feed a timer counter 736 that may be used to determine timing for pulse signal generation in conjunction with a timer compare logic 738. The timer compare logic 738 may be configured to determine when specific clock values from the timer counter 736 occur in order to generate the pulse. The block 738 may be used to generate both a signal's frequency and the signal's duty cycle. For example, comparing the count from the timer counter 736 to a first compare value may cause the count from the timer counter 736 to be reset to 0 (e.g., assuming up counter). Similarly, comparing the count from the timer counter 736 to a second compare value may cause an output single of the timer compare logic 738 to toggle (e.g., if the count value is greater than the second compare value, output a logical high value, otherwise output a logical low value). Naturally, the first compare value is greater than the second compare value for this example.

For example, the timer compare logic 738 may compare a count from the timer counter 736 to one or more comparison values that may be stored in the timer compare logic to determine when one or more specific clock values from the timer counter 736 occur. The occurrence of the counter values may indicate that a change in the value of a signal should occur, e.g., a change from a low value to a high value or a change from a high value to a low value. A series of changes from a low value to a high value and from a high value to a low value may occur to generate the pulse signal. These changes in value may generally occur without any “bit banging” by a processor (not shown) in a motor control system implementing the systems and methods described herein. Accordingly, processor overhead related to motor control may be decreased.

The timer counter 736 and/or the timer compare logic 738 may provide an output to an interrupt controller 748 that may interrupt a CPU based on the occurrence of various timing events in the generation of the carrier. For example, an interrupt may be generated by the interrupt controller 748 periodically based on the result of a compare in the timer compare logic 738. The interrupt may be used to keep a CPU in a system implementing the systems and methods described herein aware of one or more events in the generation of the carrier, e.g., a particular number of counts occurring at counter 706, the occurrence of a particular count, or other events.

Additionally, the timer compare logic 738 may be provided with one or more inputs from the temperature, current input, and speed input block 750. The temperature, current input, and speed input block 750 may provide a signal or signals related to one or more of the temperature, the current, or the speed of a motor being controlled using the portion of the motor controller. As described above, the temperature, current, and speed may impact the control signals sent to the motor. Again, for example, for low temperatures, chopping may not be necessary. For high temperatures, chopping may be needed to stabilize or decrease the temperature of the motor. For high speeds on the motor chopping may not be needed because higher current, that may be provided by un-chopped signals, may be needed to increase torque. For lower speeds, the energy from the current may be dissipated as heat, which may lead to a need to chop the motor's input signals. Furthermore, the current used by the motor may also provide an indication if chopping is needed or not needed because the energy from the current may be dissipated as heat. Additionally, the feedback from the temperature, current input, and speed input block 750 may be used to alter both frequency and duty cycle of carriers and pulse generators. Accordingly, in addition to altering the chopping or carrier signal, some examples may use feedback from the temperature, current input, and speed input block 750 to alter pulse generator control signals. For example, frequency and duty cycle may be altered to decrease temperature of a motor, lower the current being supplied to the motor, decrease the rotational speed of the motor, or some combination of these.

The timer compare logic 738 may drive another Output POLarity block (Output POL) 740. The POL 740 may drive a buffer 742. The buffer 742 may be coupled to Boolean logic 744 that may combine a signal from the first signal generation circuit 702 used to generate the output pulse. The Boolean logic used may be one or more of AND, OR, XOR, NAND, NOR, or any combination of Boolean logic, flip-flops, latches or other circuitry. For example, the signal output from the Boolean logic may be the signals (chopped or un-chopped) that may drive a brushless motor, e.g., through output 746. The signal output from the Boolean logic may drive a brushless motor in conjunction with another signal output from Boolean logic in another pulse generator, as discussed with respect to FIG. 1.

Again, as described herein, the carrier 404 has generally been depicted as the higher frequency signal with respect to the internal pulse 412. It will be understood, however, that the components generating the higher frequency signal and the lower frequency signal may be swapped. Accordingly, the carrier generation component (e.g., first signal generation circuit 702) may generate the lower frequency signal and the pulse generator component (e.g., second signal generation circuit 732) may generate the higher frequency signals in another example.

Referring back to FIGS. 1-7 a motor controller may include carrier generator components 402, 502, 506, 510, 514, 518, 522, 602, (first signal generation circuit 702) each for providing carriers to one or more of pulse generator components 406, 504, 508, 512, 516, 520, 524, 604, 608, 612, 616, 620, 624, (second signal generation circuit 732). Pulse generator components 406, 504, 508, 512, 516, 520, 524, 604, 608, 612, 616, 620, 624, (second signal generation circuit 732) each provide a pulse at a duty cycle. The pulse generator components 406, 504, 508, 512, 516, 520, 524, 604, 608, 612, 616, 620, 624, (second signal generation circuit 732) each may be coupled to one (or more) of the carrier generator component 402, 502, 506, 510, 514, 518, 522, 602, (first signal generation circuit 702). Additionally, the pulse generator components 406, 504, 508, 512, 516, 520, 524, 604, 608, 612, 616, 620, 624, (second signal generation circuit 732) may be configured to combine the pulse with the carrier to generate an output pulse. The pulse generator components 406, 504, 508, 512, 516, 520, 524, 604, 608, 612, 616, 620, 624, (second signal generation circuit 732) may each be configured to output an output pulse to drive a leg 110, 112, 114 of the brushless motor 108. (As discussed with respect to FIG. 1, a pair of outputs may drive a leg 110, 112, 114 of the brushless motor 108, e.g., one tied to V_{cc} and one tied to ground.)

The pulse generator components 406, 504, 604, (second signal generation circuit 732) may be a first pulse generator component 406, 504, 604, (second signal generation circuit 732) for providing a first internal pulse 412 at a duty cycle. Additionally, the first pulse generator component 406, 504, 604, (second signal generation circuit 732) may be configured to combine the first internal pulse 412 with the first carrier 404 from a first carrier generator component 402, 502, (first signal generation circuit 702) to generate a first output pulse (at output 408, R, 746). The first pulse generator component 406, 504, 604, (second signal generation circuit 732) may be coupled to the first carrier generator component 402, 502, (first signal generation circuit 702). The first pulse generator component 406, 504, 604, (second signal generation circuit 732) may be configured to output a first output pulse to drive a first leg 110 of the brushless motor 108.

The pulse generator components 406, 508, 608, (second signal generation circuit 732) may be a second pulse generator component 406, 508, 608, (second signal generation circuit 732) for providing a second internal pulse 412 at a duty cycle. Additionally, the second pulse generator component 406, 508, 608, (second signal generation circuit 732) may be configured to combine the second internal pulse 412 with a carrier 404 from a second carrier generator component 402, 506, (first signal generation circuit 702) to generate a second output pulse (at output 408, R′, 746). The second pulse generator component 406, 508, 608, (second signal generation circuit 732) may be coupled to the second carrier generator component 402, 506, (first signal generation circuit 702). The second pulse generator component 406, 508, 608, (second signal generation circuit 732) may be configured to output a second output pulse to drive the first leg 110 of the brushless motor 108.

The pulse generator component 406, 512, 612, (second signal generation circuit 732) may be a third pulse generator component 406, 512, 612, (second signal generation circuit 732) for providing a third internal pulse 412 at a duty cycle. Additionally, the third pulse generator component 406, 512, 612, (second signal generation circuit 732) may be configured to combine the third internal pulse 412 with a carrier 404 from a third carrier generator component 402, 510, (first signal generation circuit 702) to generate a third output pulse (at the output 408, G, 746). The third pulse generator component 406, 512, 612, (second signal generation circuit 732) may be coupled to the third carrier generator component 402, 510, (first signal generation circuit 702). The third pulse generator component 406, 512, 612, (second signal generation circuit 732) may be configured to output a third output pulse to drive a second leg 112 of the brushless motor 108.

The pulse generator component 406, 516, 616, (second signal generation circuit 732) may be a fourth pulse generator component 406, 516, 616, (second signal generation circuit 732) for providing a fourth internal pulse 412 at a duty cycle. Additionally, the fourth pulse generator component 406, 516, 616, (second signal generation circuit 732) may be configured to combine the fourth internal pulse 412 with a carrier 404 from a fourth carrier generator component 402, 514, (first signal generation circuit 702) to generate a fourth output pulse (at the output 408, G′, 746). The fourth pulse generator component 406, 516, 616, (second signal generation circuit 732) may be coupled to the fourth carrier generator component 402, 514, (first signal generation circuit 702). The fourth pulse generator component 406, 516, 616, (second signal generation circuit 732) may be configured to output a fourth output pulse to drive a second leg 112 of the brushless motor 108.

The pulse generator component 406, 520, 620, (second signal generation circuit 732) may be a fifth pulse generator component 406, 520, 620, (second signal generation circuit 732) for providing a fifth internal pulse 412 at a duty cycle. Additionally, the fifth pulse generator component 406, 520, 620, (second signal generation circuit 732) may be configured to combine the fifth internal pulse 412 with a carrier 404 from a fifth carrier generator component 402, 518, (first signal generation circuit 702) to generate a fifth output pulse (at the output 408, B, 746). The fifth pulse generator component 406, 520, 620, (second signal generation circuit 732) may be coupled to the fifth carrier generator component 402, 518, (first signal generation circuit 702). The fifth pulse generator component 406, 520, 620, (second signal generation circuit 732) may be configured to output a fifth output pulse to drive a third leg 114 of the brushless motor 108.

The pulse generator component 406, 524, 624, (second signal generation circuit 732) may be a sixth pulse generator component 406, 524, 624, (second signal generation circuit 732) for providing a sixth internal pulse 412 at a duty cycle. Additionally, the sixth pulse generator component 406, 524, 624, (second signal generation circuit 732) may be configured to combine the sixth internal pulse 412 with a carrier 404 from a sixth carrier generator component 402, 522, (first signal generation circuit 702) to generate a sixth output pulse (at the output 408, B′, 746). The sixth pulse generator component 406, 524, 624, (second signal generation circuit 732) may be coupled to the sixth carrier generator component 402, 522, (first signal generation circuit 702). The sixth pulse generator component 406, 524, 624, (second signal generation circuit 732) may be configured to output a sixth output pulse to drive a third leg 114 of the brushless motor 108.

In some examples, the first carrier generator component 402 may be configured to receive an input for adjusting a frequency of the first carrier. The input may be a function of at least one of a temperature of the motor, a load current of motor, or a speed of the motor.

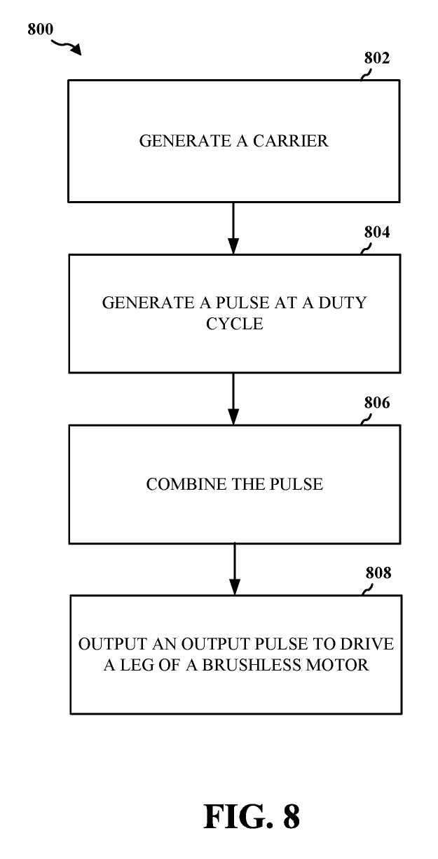

FIG. 8 is a flowchart 800 illustrating an example method for motor control in accordance with the systems and methods described herein. In a block 802, a carrier generator component generates a carrier 404. The carrier generator component may be one of carrier generator component 402 of FIG. 4, carrier generator components 502, 506, 510, 514, 518, 522 of FIG. 5, carrier generator component 602 of FIG. 6, or the first signal generation circuit 702 of FIG. 7. For example, the clock source 704, timer counter 706, and timer compare logic 708 of FIG. 7 may, e.g., in combination, be used to generate a carrier 404.

In a block 804, a pulse generator component generates a pulse at a duty cycle. The pulse generator component may be one of pulse generator component 406 of FIG. 4, pulse generator components 504, 508, 512, 516, 520, 524 of FIG. 5, pulse generator components 604, 608, 612, 616, 620, 624 of FIG. 6, or the second signal generation circuit 732 of FIG. 7. For example, the clock source 734, timer counter 736, timer compare logic 738, in combination with Boolean logic 744 of FIG. 7 may be used to generate a pulse. The Boolean logic may combine a signal generated by the clock source 734, timer counter 736, and timer compare logic 738 with the carrier generated by the clock source 704, timer counter 706, and timer compare logic 708, e.g., the pulse.

In a block 806, the pulse generator component (or other combining circuitry) may combine the first pulse with the first carrier to generate a first output pulse. The pulse generator component may be one of pulse generator component 406 of FIG. 4, pulse generator components 504, 508, 512, 516, 520, 524 of FIG. 5, pulse generator components 604, 608, 612, 616, 620, 624 of FIG. 6, or the second signal generation circuit 732 of FIG. 7. For example, the Boolean logic 744 in the second signal generation circuit 732 of FIG. 7 may combine the first pulse with the first carrier to generate a first output pulse.

In a block 808, the pulse generator component (or other output circuitry) may output an output pulse to drive a leg 110, 112, 114 of the brushless motor 108. The pulse generator component may be one of pulse generator component 406 of FIG. 4, pulse generator components 504, 508, 512, 516, 520, 524 of FIG. 5, pulse generator components 604, 608, 612, 616, 620, 624 of FIG. 6, or the second signal generation circuit 732 of FIG. 7. For example, the Boolean logic 744 may drive an output 746 that may output an output pulse to drive a leg 110, 112, 114 of the brushless motor 108.

Some examples may include means for generating a carrier. The means for generating a carrier may be a carrier generator component. The means for generating a carrier may be one of carrier generator component 402 of FIG. 4, carrier generator components 502, 506, 510, 514, 518, 522 of FIG. 5, carrier generator component 602 of FIG. 6, or the first signal generation circuit 702 of FIG. 7. For example, the clock source 704, timer counter 706, and timer compare logic 708 of FIG. 7 may be the means to generate a carrier.

Some examples may include means for generating a pulse at a duty cycle. The means for generating a pulse at a duty cycle may be a pulse generator component. The pulse generator component may be one of pulse generator component 406 of FIG. 4, pulse generator components 504, 508, 512, 516, 520, 524 of FIG. 5, pulse generator components 604, 608, 612, 616, 620, 624 of FIG. 6, or the second signal generation circuit 732 of FIG. 7. For example, the clock source 734, timer counter 736, timer compare logic 738, in combination with Boolean logic 744 of FIG. 7 may be the means for generating a pulse. The Boolean logic may combine a signal generated by the clock source 734, timer counter 736, and timer compare logic 738, with the carrier generated by the clock source 704, timer counter 706, and timer compare logic 708 to generate the pulse. The Boolean logic may be the means for generating a pulse.

Some examples may include means for combining the first pulse with the first carrier to generate a first output pulse. The means for combining the first pulse with the first carrier to generate a first output pulse may be the pulse generator component. For example, the Boolean logic 744 in the second signal generation circuit 732 of FIG. 7 may combine the first pulse with the first carrier to generate a first output pulse. Accordingly, the Boolean logic 744 in the second signal generation circuit 732 of FIG. 7 may be the means for combining the first pulse with the first carrier to generate a first output pulse.

Some examples may include means for outputting an output pulse to drive a leg 110, 112, 114 of the brushless motor 108. The means for outputting an output pulse to drive a leg 110, 112, 114 of the brushless motor 108 may be the pulse generator component. For example, the Boolean logic 744 may drive an output 746 that outputs an output pulse to drive a leg 110, 112, 114 of the brushless motor 108. Accordingly, the Boolean logic 744 and/or the output 746 may be the means for outputting an output pulse to drive a leg 110, 112, 114 of the brushless motor 108.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A motor controller for controlling a brushless motor, comprising:
a first carrier generator component for providing a first carrier; and
a first pulse generator component for providing a first pulse at a duty cycle, the first pulse generator component being coupled to the first carrier generator component and being configured to combine the first pulse with the first carrier to generate a first output pulse, and to output the first output pulse to drive a first leg of the brushless motor.

2. The motor controller of claim 1, further comprising a second pulse generator component for providing a second pulse at the duty cycle, the second pulse generator component being configured to output a second output pulse to drive the first leg of the brushless motor.

3. The motor controller of claim 2, wherein the second pulse generator component is coupled to the first carrier generator component and is configured to combine the second pulse with the first carrier to generate the second output pulse.

4. The motor controller of claim 2, further comprising a second carrier generator component for providing a second carrier, wherein the second pulse generator component is coupled to the second carrier generator component and is configured to combine the second pulse with the second carrier to generate the second output pulse.

5. The motor controller of claim 2, further comprising a third pulse generator component for providing a third pulse at the duty cycle, the third pulse generator component being configured to output a third output pulse to drive a second leg of the brushless motor.

6. The motor controller of claim 5, wherein the third pulse generator component is coupled to the first carrier generator component and is configured to combine the third pulse with the first carrier to generate the third output pulse.

7. The motor controller of claim 5, further comprising a third carrier generator component for providing a second carrier, wherein the third pulse generator component is coupled to the second carrier generator component and is configured to combine the third pulse with the second carrier to generate the third output pulse.

8. The motor controller of claim 5, further comprising a fourth pulse generator component for providing a fourth pulse at the duty cycle, the fourth pulse generator component being configured to output a fourth output pulse to drive the second leg of the brushless motor.

9. The motor controller of claim 8, wherein the fourth pulse generator component is coupled to the first carrier generator component and is configured to combine the fourth pulse with the first carrier to generate the fourth output pulse.

10. The motor controller of claim 8, further comprising a second carrier generator component for providing a second carrier, wherein the fourth pulse generator component is coupled to the second carrier generator component and is configured to combine the fourth pulse with the second carrier to generate the fourth output pulse.

11. The motor controller of claim 8, further comprising a fifth pulse generator component for providing a fifth pulse at the duty cycle, the fifth pulse generator component being configured to output a fifth output pulse to drive a third leg of the brushless motor.

12. The motor controller of claim 11, wherein the fifth pulse generator component is coupled to the first carrier generator component and is configured to combine the fifth pulse with the first carrier to generate the fifth output pulse.

13. The motor controller of claim 11, further comprising a second carrier generator component for providing a second carrier, wherein the fifth pulse generator component is coupled to the second carrier generator component and is configured to combine the fifth pulse with the second carrier to generate the fifth output pulse.

14. The motor controller of claim 11, further comprising a sixth pulse generator component for providing a sixth pulse at the duty cycle, the sixth pulse generator component being configured to output a sixth output pulse to drive the third leg of the brushless motor.

15. The motor controller of claim 14, wherein the sixth pulse generator component is coupled to the first carrier generator component and is configured to combine the sixth pulse with the first carrier to generate the sixth output pulse.

16. The motor controller of claim 14, further comprising a second carrier generator component for providing a second carrier, wherein the sixth pulse generator component is coupled to the second carrier generator component and is configured to combine the sixth pulse with the second carrier to generate the sixth output pulse.

17. The motor controller of claim 1, wherein the first carrier generator component is configured to receive an input for adjusting a frequency of the first carrier, the input being a function of at least one of a temperature of the motor, a load current of motor, or a speed of the motor.

18. The motor controller of claim 1, wherein the first pulse generator component is configured to receive an input for adjusting the duty cycle of the first pulse output, the input being a function of at least one of a temperature of the motor, a load current of motor, or a speed of the motor.

19. A method for controlling a brushless motor, comprising:
generating a first carrier in a first carrier generator component; and
generating a first pulse at a duty cycle in a first pulse generator component;
combining the first pulse with the first carrier to generate a first output pulse; and
outputting the first output pulse to drive a first leg of the brushless motor.

20. The method of claim 19, further comprising providing a second pulse at the duty cycle using a second pulse generator component and outputting a second output pulse to drive the first leg of the brushless motor.

21. The method of claim 20, further comprising combining the second pulse with the first carrier to generate the second output pulse.

22. The method of claim 20, further comprising generating a second carrier and combining the second pulse with the second carrier to generate the second output pulse.

23. The method of claim 20, further comprising generating a third pulse at the duty cycle, and outputting a third output pulse to drive a second leg of the brushless motor.

24. The method of claim 23, further comprising combining the third pulse with the first carrier to generate the third output pulse.

25. The method of claim 23, further comprising generating a second carrier, and combining the third pulse with the second carrier to generate the third output pulse.

26. The method of claim 23, further comprising generating a fourth pulse at the duty cycle, and outputting a fourth output pulse to drive the second leg of the brushless motor.

27. The method of claim 26, further comprising combining the fourth pulse with the first carrier to generate the fourth output pulse.

28. The method of claim 26, further comprising generating a second carrier, and combining the fourth pulse with the second carrier to generate the fourth output pulse.

29. The method of claim 26, further comprising generating a fifth pulse at the duty cycle, and outputting a fifth output pulse to drive a third leg of the brushless motor.

30. A motor controller for controlling a brushless motor, comprising:
means for generating a first carrier in a first carrier generator component; and
means for generating a first pulse at a duty cycle in a first pulse generator component;
means for combining the first pulse with the first carrier to generate a first output pulse; and
means for outputting the first output pulse to drive a first leg of the brushless motor.
